(19) United States
(12) Patent Application Publication
(10) Pub. No.: US 2008/0252195 A1
(43) Pub. Date: Oct. 16, 2008

(54) FIELD-EMISSION-BASED FLAT LIGHT SOURCE

(75) Inventors: LIANG LIU, Beijing (CN); JIE TANG, Beijing (CN); ZHI ZHENG, Beijing (CN); LI QIAN, Beijing (CN); SHOU-SHAN FAN, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/959,132

(22) Filed: Dec. 18, 2007

(30) Foreign Application Priority Data
Apr. 13, 2007 (CN) 200710074018.6

(51) Int. Cl. H01J 1/62

(52) U.S. Cl. 313/496

(57) ABSTRACT

A field-emission-based flat light source includes a light-permeable substrate, a transparent electrically conductive cathode, an electron emitter, an anode layer, a light-reflecting layer, a fluorescent layer. The light-permeable substrate has a surface. The transparent electrically conductive cathode layer is disposed on the surface of the light-permeable substrate. The electron emitter is disposed on the transparent electrically conductive cathode layer. The anode layer faces and is spaced from the transparent electrically conductive cathode layer. A vacuum chamber is formed between the anode layer and the transparent electrically conductive cathode layer. The light-reflecting layer is formed on the anode layer, and faces the transparent electrically conductive cathode layer. The fluorescent layer is formed on the light-reflecting layer.

### RELATED APPLICATIONS

This application is related to commonly-assigned application entitled, “FIELD-EMISSION-BASED FLAT LIGHT SOURCE”, filed ______ (Atty. Docket No. US14310). Disclosure of the above-identified application is incorporated herein by reference.

### BACKGROUND

1. Field of the Invention

The present invention relates to a flat light source and, particularly, to a field-emission-based flat light source.

2. Discussion of Related Art

Flat light sources are widely used in many fields, especially in display technology. Many light receiving display devices, such as liquid crystal displays (LCDs), need a flat light source to provide a uniform incidence light. Generally, a flat light source used in LCD converts a linear light source to a flat, area light source through an optical means. However, the conventional flat light source typically inefficiently utilizes light energy.

To improve the efficiency of the light energy utilization, a conventional field-emission-based flat light source is provided. The field-emission-based flat light source includes a cathode electrode, a transparent anode electrode spaced from the cathode electrode, and a fluorescent layer formed on the anode electrode. When a predetermined voltage is applied between the anode electrode and the cathode electrode, electrons are able to emit from the cathode electrode and move to the anode electrode. When the emitted electrons collide against the fluorescent layer, a visible light is produced and transmitted through the transparent anode electrode to the outside as a flat, area light source.

However, in the conventional field-emission-based flat light source, light emits from the anode electrode directly. The potential non-uniformity of the thickness of the fluorescent layer and/or of the electron emission from the cathode may induce a non-uniformity of light emission of the fluorescent layer. Therefore, the uniformity of luminance of the conventional field-emission-based flat light source is decreased.

What is needed is to provide a field-emission-based flat light source, in which the above problems are eliminated or at least alleviated.

### SUMMARY OF THE INVENTION

A field-emission-based flat light source includes a light-permeable substrate, a transparent electrically conductive cathode, an electron emitter, an anode layer, a light-reflecting layer, a fluorescent layer. The light-permeable substrate has a surface. The transparent electrically conductive cathode layer is disposed on the surface of the light-permeable substrate. The electron emitter is disposed on the transparent electrically conductive cathode layer. The anode layer faces and is spaced from the transparent electrically conductive cathode layer. A vacuum chamber is formed between the anode layer and the transparent electrically conductive cathode layer. The light-reflecting layer is formed on the anode layer, and faces the transparent electrically conductive cathode layer. The fluorescent layer is formed on the light-reflecting layer.

Other advantages and novel features of the present invention of the field-emission-based flat light source will become more apparent from the following detailed description of embodiments when taken in conjunction with the accompanying drawings.

### BRIEF DESCRIPTION OF THE DRAWINGS

Many aspects of the present invention of the field-emission-based flat light source can be better understood with reference to the following drawings. The components in the drawings are not necessarily to scale, the emphasis instead being placed upon clearly illustrating the principles of the present field-emission-based flat light source.

FIG. 1 is a cross-sectional view of a field-emission-based flat light source, in accordance with a first embodiment;

FIG. 2 is a cross-sectional view of a field-emission-based flat light source, in accordance with a second embodiment;

FIG. 3 is a schematic top view of the cathode of a field-emission-based flat light source of FIG. 3;

FIG. 4 is a cross-sectional view of a field-emission-based flat light source, in accordance with a third embodiment; and

FIG. 5 is a cross-sectional view of a field-emission-based flat light source, in accordance with a fourth embodiment.

Corresponding reference characters indicate corresponding parts throughout the several views. The exemplifications set out herein illustrate at least one embodiment of the present field-emission-based flat light source, in at least one form, and such exemplifications are not to be construed as limiting the scope of the invention in any manner.

### DETAILED DESCRIPTION OF PREFERRED EMBODIMENTS

Reference will now be made to the drawings to describe, in detail, embodiments of the present field-emission-based flat light source.

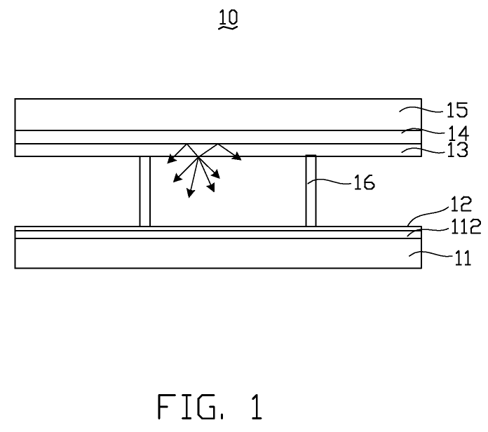

Referring to FIG. 1, the field-emission-based flat light source 10 in the first embodiment includes a light-permeable substrate 11, a transparent electrically conductive cathode layer 112, a electron emitter 12, a fluorescent layer 13, a light-reflecting layer 14, an anode layer 15, and a plurality of spacers 16. The transparent electrically conductive cathode layer 112 is located on a surface of the light-permeable substrate 11. The electron emitter 12 is disposed on the transparent electrically conductive cathode layer 112. The anode layer 15 faces the electron emitter 12 and is spaced from the electron emitter 12 by the spacers 16 to form a vacuum chamber. The light-reflecting layer 14 is formed on the anode layer 15 and faces the electron emitter 12. The fluorescent layer 13 is formed on the light-reflecting layer 14.

The spacers 16 are advantageously made of an insulative material, such as a glass or ceramic material, to provide high strength and to avoid shorting between the electron emitter 12 and the anode layer 15. The anode layer 15 can, usefully, be made of a conductive material, such as a metal, or of an insulative material with a conductive layer formed thereon. The conductive layer can, beneficially, be made of gold, silver, copper, aluminum, or nickel. The light-reflecting layer 14 can, advantageously, include a light-reflecting sheet or a light-reflecting film coated on the surface of the anode layer 15. Because of the high reflectivity of silver and/or aluminum, the conductive layer can be used as the light-reflecting layer 14 when the conductive layer is formed of silver and/or aluminum material.

The light-permeable substrate 11 can, usefully, be made of a transparent material such as a transparent glass panel. The transparent electrically conductive cathode layer 112 can, suitably, be made of an indium tin oxide (ITO) film. The electron emitter 12 can, beneficially, include a transparent carbon nanotube film. The thickness of the transparent carbon nanotube film is in the approximate range from 0.5 nanometers to 100 microns. In one useful embodiment, the transparent carbon nanotube film can be fixed on the transparent electrically conductive cathode layer 112 by using an adhesive/glue.

A method for fabricating the transparent carbon nanotube film includes the steps of: (a) providing an array of carbon nanotubes, quite suitably, providing a super-aligned array of carbon nanotubes; (b) selecting a plurality of carbon nanotube segments having a predetermined width from the array of carbon nanotubes by using a tool (e.g., adhesive tape or another tool allowing multiple carbon nanotubes to be gripped and pulled simultaneously); (c) pulling the carbon nanotube segments out of the array of carbon nanotubes at an even/uniform speed to form the carbon nanotube film.

In step (b), quite usefully, the carbon nanotube segments having a predetermined width can be selected by using a wide adhesive tape as the tool to contact the super-aligned array. In step (c), the pulling direction is, usefully, substantially perpendicular to the growing direction of the super-aligned array of carbon nanotubes.

More specifically, during the pulling process, as the initial carbon nanotube segments are drawn out, other carbon nanotube segments are also drawn out end to end, due to the van der Waals attractive force between ends of the adjacent segments. This process of drawing ensures a successive carbon nanotube film can be formed. The carbon nanotubes of the carbon nanotube film are all substantially parallel to the pulling direction, and the carbon nanotube film produced in such manner is able to formed to have a selectable, predetermined width.

It is to be understood that, a plurality of carbon nanotube films can be formed and overlapped with each other to form a multi-layer carbon nanotube film. The aligned directions of the carbon nanotube films can be different. In the multi-layer carbon nanotube film, the number of the layers is arbitrary and depends on the actual needs/use. The layers of carbon nanotube film are combined (i.e., attached to one another) by van de Waals attractive force to form a stable multi-layer film. A thickness of the carbon nanotube film can, suitably, be in the approximate range from 0.5 nanometers to 100 microns.

In the flat light source 10 of the first embodiment, electrons are emitted from the electron emitter 12 and collide with the fluorescent layer 13 on the anode layer 15. Visible light produced by the collisions partially emits directly from the light-permeable substrate 11. The remaining part of the visible light is reflected by the light-reflecting layer 14 and then emits from the light-permeable substrate 11. Due to the transmission step in the vacuum chamber between the light-permeable substrate 11 and the anode layer 15, the uniformity of the luminance is increased.

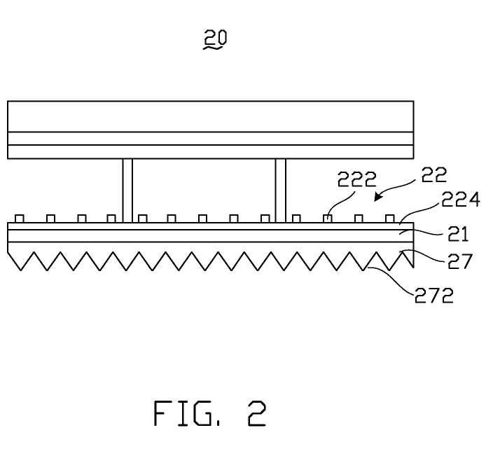

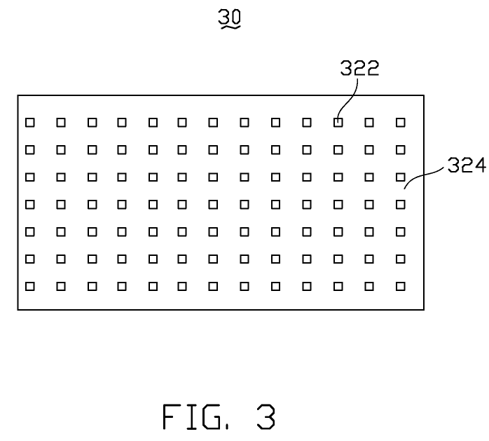

Referring to FIG. 2 and FIG. 3, a field-emission-based flat light source 20 in the second embodiment is similar to the field-emission-based flat light source 10 in the first embodiment. A transparent electrically conductive cathode layer 224 is disposed on a light-permeable substrate 21. The transparent electrically conductive cathode layer 224 can, suitably, be made of an indium tin oxide (ITO) film. Different from the electron emitter 12 of the field-emission-based flat light source 10 in the first embodiment, an electron emitter 22 of the field-emission-based flat light source 20 in the second embodiment includes a plurality of lattice-patterned emitters 222. The emitters 222 are disposed on the transparent electrically conductive cathode layer 224. The emitters 222 include carbon nanotubes, conductive metal grains, and low-melting point glass. The shape of the emitters 222 can, usefully, be selected from a group consisting of rectangular prisms, cubes, columns, cones, truncated cones, and any combination thereof. In one useful embodiment, the emitters 222 are cubes, and the sides are in the approximate range from 50 nanometers to 1 millimeter.

Additionally, a diffuser 27 is disposed on the lower side of the light-permeable substrate 21 and includes a plurality of diffusion (i.e., light-diffusing) structures 272 formed directly thereon. The shape of the diffusion structures 272 of the diffuser 27 can, beneficially, be selected from a group consisting of convex or concave columns, semi-spheres, pyramids, truncated pyramids, and any combination thereof. In one useful embodiment, the diffusion structures 272 are pyramids formed by injection molding.

The lattice-patterned emitters 222 of the electron emitter 22 can be made by a screen printing method, which includes the steps of: (a) providing a carbon nanotube paste and the light-permeable substrate 21 with the transparent electrically conductive cathode layer 224 formed thereon; (b) providing a template with lattice-patterned through holes, and disposing the template on the transparent electrically conductive cathode layer 224; (c) filling the through holes with the carbon nanotube paste; (d) removing the template and, drying and sintering the light-permeable substrate 21 to form the lattice-patterned emitters 222.

In step (a), the carbon nanotube paste consists of about 5%˜15% carbon nanotubes, about 10%˜20% conductive metal grains, about 5% low-melting point glass, and about 60% to 80% organic carrier. The material of conductive metal grains can, beneficially, be selected from a group consisting of indium tin oxide (ITO) and silver, and provide a electrical connection between the carbon nanotubes and the transparent electrically conductive cathode layer. The organic carrier is a mixture of terpineol as a solvent, a small amount/percentage of dibutyl phthalate as a plasticizer, and a small amount/percentage of ethyl cellulose as a stabilizer. In the present embodiment, the amount of terpineol, dibutyl phthalate and ethyl cellulose is in the ratio of about 90:5:5. The mixture can be sonicated (i.e., ultrasonically vibrated and mixed) to provide a paste with the above-mentioned paste components uniformly dispersed therein.

Quite suitably, the length of the carbon nanotubes is in the approximate range from 5 to 15 microns. The field emission performance will be reduced, when the carbon nanotubes have relatively small length. Whereas, the carbon nanotubes will bend or break when the length thereof are relatively long. The melting point of the low-melting point glass can, beneficially, be in the approximate range from 400° C. to 500° C. The low-melting point glass can be melted in the sintering step, and used to bond the carbon nanotubes to the transparent electrically conductive cathode layer 224.

In step (b), the template can be made by conventional means of screen-printing (e.g. forming a sensitizing layer on a screen and forming the through holes thereon with exposing and profiling steps.). In step (c), the carbon nanotube paste can be put into the through holes by using a rubber blade. In step (d), the light-permeable substrate 21 can be dried in an oven (e.g., via evaporation and/or burn-off at about 75° C.˜120° C.) or in room temperature to eliminate the organic carrier in the carbon nanotube paste. The low-melting point glass can be melted in the sintering step, and used to bond the carbon nanotubes to the transparent electrically conductive cathode layer 224. The melting point of the transparent electrically conductive cathode layer 224 is higher than that of the low-melting point glass.

In one useful embodiment, the step (d) further includes an abrasion step for the emitters 222 after the sintering step, in order to enhance the field emission property thereof. The carbon nanotubes extrude from the paste and have a preferred orientation after the abrasion step.

As the amount of the emitters 222 increases, electron emission will increase but the light output through the light-permeable substrate 21 will decrease. Thus, the distribution density of the emitters 222 is not specifically confined and is set to provide a maximum light output. In one suitable embodiment, the distance between two adjacent emitters 222 is in the approximate range from 10 microns to 10 millimeters. The field-emission-based flat light source 20 in the second embodiment has more uniformity of emitting density and output light than the field-emission-based flat light source 10 in the first embodiment.

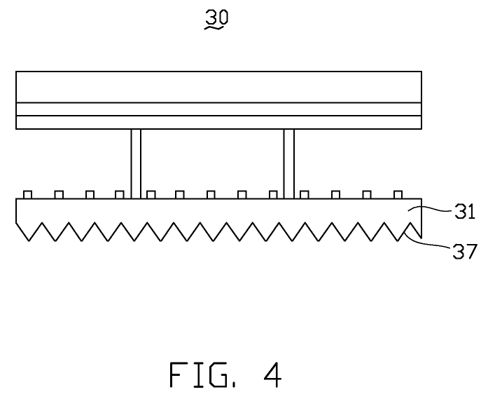

Referring to FIG. 4, the field-emission-based flat light source 30 in the third embodiment is similar to the field-emission-based flat light source 20 in the second embodiment. A light-permeable substrate 31 and a diffuser 37 are integrally formed (e.g., injection molding). Therefore, no interface between the light-permeable substrate 31 and the diffuser 37 exists. As such, the transmittance and luminescent efficiency of the flat light source 30 are elevated.

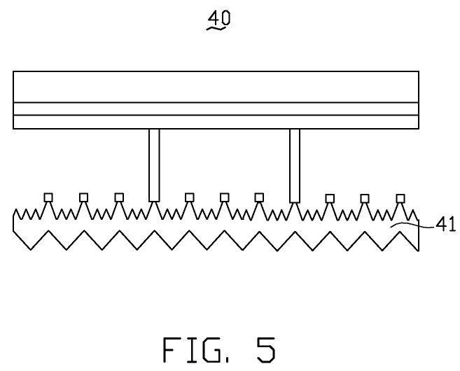

Referring to FIG. 5, the field-emission-based flat light source 40 in the fourth embodiment is similar to the field-emission-based flat light source 30 in the third embodiment. Two diffusers are formed on the two main opposite surfaces of a light-permeable substrate 41. The diffusers and the light-permeable substrate 41 are integrally formed. The two diffusers on the opposing sides of the light-permeable substrate 41 can be formed by, e.g., injection molding (i.e., inject the melted glass into a mold) or glass etching of the initial light-permeable substrate 41. The uniformity of the output light can be elevated through the light-permeable substrate 41, as there are no respective interfaces between it and the two diffusers associated therewith, and, of course, the two diffusers themselves promote uniform light output, via diffusion.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A field-emission-based flat light source, comprising:
a light-permeable substrate having a surface;
a transparent electrically conductive cathode layer disposed on the surface of the light-permeable substrate;
an electron emitter disposed on the transparent electrically conductive cathode layer;
an anode layer facing and spaced from the transparent electrically conductive cathode layer, a vacuum chamber being formed between the anode layer and the transparent electrically conductive cathode layer;
a light-reflecting layer formed on the anode layer, the light-reflecting layer facing the transparent electrically conductive cathode layer; and
a fluorescent layer formed on the light-reflecting layer.

2. The field-emission-based flat light source as claimed in claim 1, wherein the electron emitter comprises a light-permeable carbon nanotube layer.

3. The field-emission-based flat light source as claimed in claim 2, wherein the carbon nanotube layer comprises at least one carbon nanotube film.

4. The field-emission-based flat light source as claimed in claim 3, wherein a thickness of the carbon nanotube layer is in the approximate range from 0.5 nanometers to 100 microns.

5. The field-emission-based flat light source as claimed in claim 3, wherein the carbon nanotube film comprises a plurality of carbon nanotubes, the carbon nanotubes are aligned in the same direction and parallel to the surface of the light-permeable substrate.

6. The field-emission-based flat light source as claimed in claim 5, wherein the carbon nanotube film comprises a plurality of ordered and successive carbon nanotube bundles joined end to end by the van der Waals attractive force.

7. The field-emission-based flat light source as claimed in claim 1, wherein the electron emitter comprises a plurality of emitters arranged in columns and rows.

8. The field-emission-based flat light source as claimed in claim 7, wherein the emitters comprise carbon nanotubes, conductive metal grains, and low-melting point glass.

9. The field-emission-based flat light source as claimed in claim 7, wherein the shape of the emitters are selected from a group consisting of rectangular prisms, cubes, columns, cones, truncated cones, and any combination thereof.

10. The field-emission-based flat light source as claimed in claim 9, wherein sides of the cubes are in the approximate range from 50 nanometers to 1 millimeter.

11. The field-emission-based flat light source as claimed in claim 1, further comprising a diffuser arranged on an opposite side of the light-permeable substrate to the transparent electrically conductive cathode layer.

12. The field-emission-based flat light source as claimed in claim 11, wherein the diffuser is integrally formed with the light-permeable substrate.

13. The field-emission-based flat light source as claimed in claim 11, wherein the diffuser comprises a plurality of light-diffusing structures, the diffuser structures being selected from a group consisting of convex columns, concave columns, semi-spheres, pyramids, truncated pyramids, and any combination thereof.

14. The field-emission-based flat light source as claimed in claim 1, wherein the light-permeable substrate is a glass plate.

15. The field-emission-based flat light source as claimed in claim 1, wherein the anode layer is selected from a group consisting of a metal plate and an insulative plate formed with an electrically conductive layer.

16. A field-emission-based flat light source comprising:
a light-permeable substrate;
a transparent electrically conductive cathode layer disposed on the light-permeable substrate;
an electron emitter disposed on the transparent electrically conductive cathode layer;
an anode layer opposite to and spaced from the transparent electrically conductive cathode layer;
a phosphor layer formed on the anode layer for producing light; and
a light-reflecting layer formed between the anode layer and the phosphor layer, the light-reflecting layer being configured for reflecting the light toward the transparent electrically conductive cathode layer.

17. The field-emission-based flat light source as claimed in claim 16, wherein the electron emitter is at least one carbon nanotube film, the carbon nanotube film comprises a plurality of carbon nanotubes, the carbon nanotubes are aligned in the same direction and parallel to a surface of the light-permeable substrate.

18. The field-emission-based flat light source as claimed in claim 17, a thickness of the carbon nanotube layer is in the approximate range from 0.5 nanometers to 100 microns.

19. The field-emission-based flat light source as claimed in claim 16, wherein a light diffuser is arranged at an opposite side of the light-permeable substrate to the transparent electrically conductive cathode layer.

20. The field-emission-based flat light source as claimed in claim 19, wherein the light diffuser is a unitary portion of the light-permeable substrate.
